(19) United States
(12) Patent Application Publication
(10) Pub. No.: US 2019/0094090 A1
(43) Pub. Date: Mar. 28, 2019

(54) APPARATUS FOR MEASURING EXERCISE QUANTITY

(71) Applicant: Microautomation CO., LTD., Daejeon (KR)

(72) Inventors: Yoon Shik Hong, Daejeon (KR); Han Jong Ju, Daejeon (KR); Sung Nam Oh, Seoul (KR); Hyun Soo Park, Daejeon (KR)

(73) Assignee: Microautomation CO., LTD.

(21) Appl. No.: 15/925,027

(22) Filed: Mar. 19, 2018

(30) Foreign Application Priority Data
Sep. 27, 2017 (KR) 10-2017-0125233

(51) Int. Cl. G01L 5/04; A63B 21/005; A63B 21/00; G01L 5/00

(52) U.S. Cl. CPC G01L 5/04; A63B 21/0055; A63B 21/151; A63B 2230/60; A63B 2220/30; A63B 2220/51; G01L 5/0095

(57) ABSTRACT

Disclosed is an apparatus for measuring an exercise quantity. The apparatus for measuring the exercise quantity includes a base fixed to the exercise machine, a load cell mounted on the upper portion of the base to measure a force applied from the upper side, a load support connected to the upper portion of the load cell to press the load cell, a load support pulley coupled to the upper portion of the load support, a guide pulley disposed beside the load support pulley so that a rotational shaft is parallel to the load support pulley, and a rotation angle measuring sensor measuring a rotation angle according to the rotation of the load support pulley, in which the belt, the cable, the rope, or the chain crosses with the load support pulley and the guide pulley.

### CROSS-REFERENCE TO RELATED APPLICATION

This application claims under 35 U.S.C. § 119(a) the benefit of Korean Patent Application No. 10-2017-0125233 filed on Sep. 27, 2017, the entire contents of which are incorporated herein by reference.

### BACKGROUND

### (a) Technical Field

The present invention relates to an apparatus for measuring an exercise quantity.

(b) Background Art

In today's society, where a technology is becoming more sophisticated and personalized, individual health care is a big concern and exercise is recognized as an essential activity for maintaining health. The exercise is largely divided into a cardiopulmonary function exercise and a muscle exercise. In recent years, the quantitative measurement of muscle movement, which is becoming more important, enables the motivation of participants of the exercise, studies on correlation with the exercise effect, and inquiry of the history of the exercise to have a high value in use. Although an aerobic cardiopulmonary function exercise can be quantitatively measured, there is no quantitative measurement of the muscle exercise.

### SUMMARY OF THE DISCLOSURE

An object of the present invention is to provide an apparatus for measuring an exercise quantity which is attached to an exercise machine using a belt, a cable, a rope, or a chain to measure tension and a movement distance of a pulled cable or belt.

According to an aspect of the present invention, there is disclosed an apparatus for measuring an exercise quantity which is attached to an exercise machine using a belt, a cable, a rope, or a chain.

The apparatus for measuring the exercise quantity includes a base fixed to the exercise machine, a load cell mounted on the upper portion of the base to measure a force applied from the upper side, a load support connected to the upper portion of the load cell to press the load cell, a load support pulley coupled to the upper portion of the load support, a guide pulley disposed beside the load support pulley so that a rotational shaft is parallel to the load support pulley, and a rotation angle measuring sensor measuring a rotation angle according to the rotation of the load support pulley, in which the belt, the cable, the rope, or the chain crosses with the load support pulley and the guide pulley.

The rotation angle measuring sensor is coupled to the load support so as to be disposed at any one of both ends of the rotational shaft of the load support pulley.

The rotation angle measuring sensor may include a plurality of magnets disposed at one end of the rotational shaft of the load support pulley at predetermined rotation angles in a rotation direction to rotate together with the load support pulley and a hall sensor disposed at a position of the load support corresponding to the position when the magnet is disposed so as to detect a magnetic force of the magnet.

The rotation angle measuring sensor is a rotary encoder measuring the rotation angle.

One side of the belt is connected to the exercise machine and the other side is connected to a handle which is held by a user for exercise, and the other side of the belt is connected to the handle via the load support pulley and the guide pulley.

When the belt is pulled by the user to generate tension, a load is generate to apply a force to the lower side of the load support to which the load support pulley is coupled.

A force of pulling the belt is calculated from the force applied to the load cell, a movement distance and a movement speed of the belt are calculated from the rotation angle, and a power rate is calculated by multiplying the force of pulling the belt and the movement speed of the belt.

The movement distance of the belt is calculated by a change amount of the rotation angle and a radius of the load support pulley.

The apparatus further includes an electric generator that generates electric power by the rotation of the load support pulley and supplies the generated electric power to the rotation angle measuring sensor.

The electric generator is coupled to the load support so that the rotational shaft of the load support pulley coincides with the rotational shaft of the electric generator.

According to the exemplary embodiment of the present invention, the apparatus for measuring the exercise quantity is attached to an exercise machine using a belt, a cable, a rope, or a chain to measure tension or a movement distance of the pulled belt, cable, rope or chain and a power rate of an exercising person is calculated from the measured tension and movement distance to check an exercise effect.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view of an apparatus for measuring an exercise quantity according to an exemplary embodiment of the present invention;

FIG. 2 is a diagram illustrating a rotation angle measuring sensor of the apparatus for measuring the exercise quantity according to the exemplary embodiment of the present invention;

FIG. 3 is a diagram for describing an operation of the apparatus for measuring the exercise quantity according to the exemplary embodiment of the present invention; and

FIG. 4 is a diagram illustrating an electric generator mounted on the apparatus for measuring the exercise quantity according to the exemplary embodiment of the present invention.

### DETAILED DESCRIPTION

Singular expressions used in the present specification include plural expressions unless they have definitely opposite meanings in the context. In the present invention, a term such as “comprising” or “including” should not be interpreted as necessarily including all various components or various steps disclosed in the invention, and it should be interpreted that some component or some steps among them may not be included or additional components or steps maybe further included. In addition, the terms of “-er” and “module” described in the specification mean units for processing at least one function and operation and can be implemented by hardware components or software components and combinations thereof.

Hereinafter, various exemplary embodiments of the present invention will be described in detail with reference to the accompanying drawings.

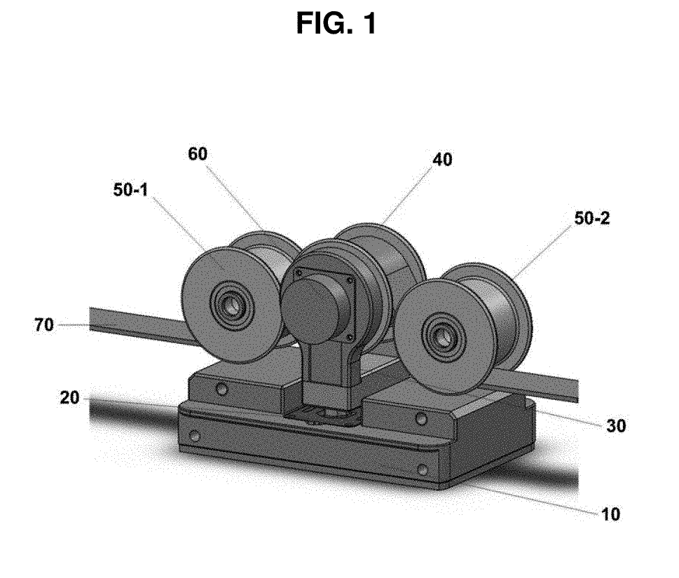

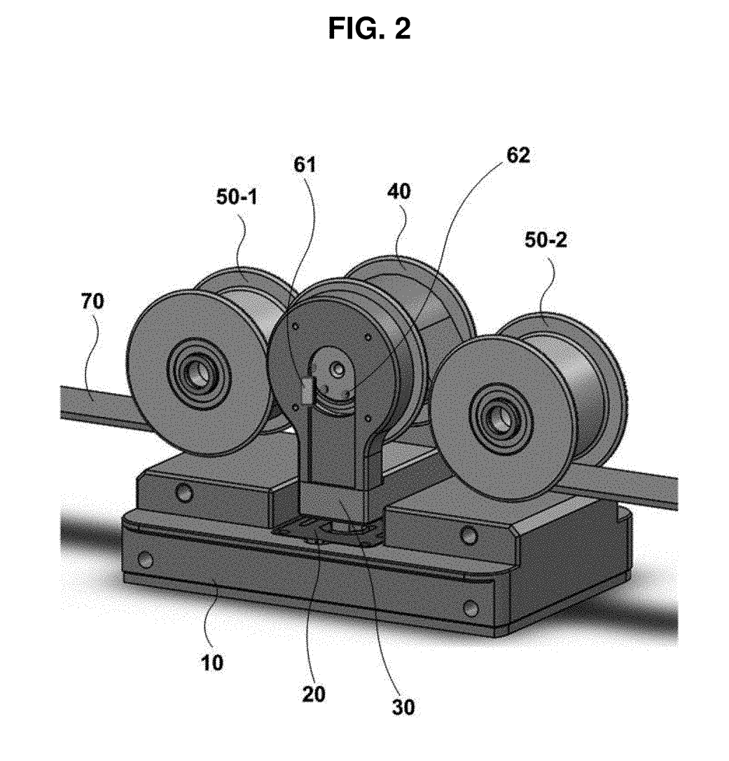

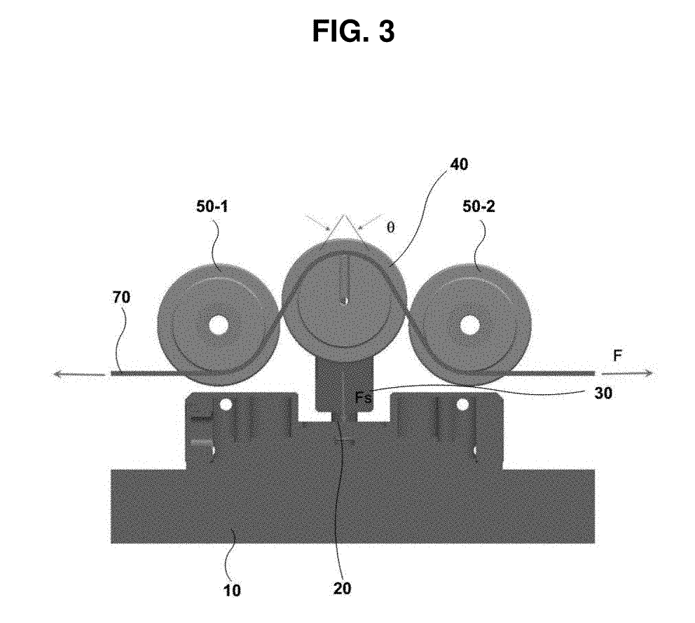

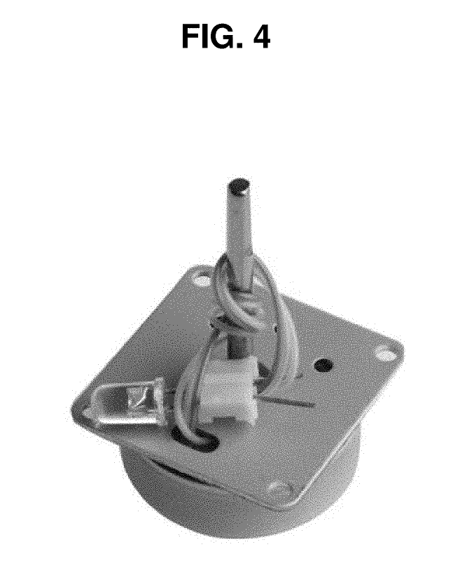

FIG. 1 is a perspective view of an apparatus for measuring an exercise quantity according to an exemplary embodiment of the present invention, FIG. 2 is a diagram illustrating a rotation angle measuring sensor of the apparatus for measuring the exercise quantity according to the exemplary embodiment of the present invention, FIG. 3 is a diagram for describing an operation of the apparatus for measuring the exercise quantity according to the exemplary embodiment of the present invention, and FIG. 4 is a diagram illustrating an electric generator mounted on the apparatus for measuring the exercise quantity according to the exemplary embodiment of the present invention. Hereinafter, a configuration of an apparatus for measuring an exercise quantity according to an exemplary embodiment of the present invention will be described based on FIG. 1 and with reference to FIGS. 2 to 4.

Referring to FIG. 1, an apparatus for measuring an exercise quantity according to an exemplary embodiment of the present invention includes a base 10, a load cell 20, a load support 30, a load support pulley 40, a guide pulleys 50-1 and 50-2, a rotation angle measuring sensor 60, and a belt 70.

The apparatus for measuring the exercise quantity according to the exemplary embodiment of the present invention is attached to an exercise machine using a belt, a cable, a rope, or a chain and connected with the exercise machine through the belt, the cable, the rope, or the chain. Hereinafter, for convenience of understanding and explanation of the present invention, it will be described by assuming that the apparatus for measuring the exercise quantity according to the exemplary embodiment of the present invention is mounted on the exercise machine to which a belt 70 of the belt, the cable, the rope, or the chain is applied.

The base 10 is attached and fixed to the exercise machine using the belt 70 to serve to support other components (for example, the load cell 20, the load support 30, the load support pulley 40, the guide pulleys 50-1 and 50-2, the rotation angle measuring sensor 60, and the belt 70) of the apparatus for measuring the exercise quantity.

The load cell 20 is mounted on the upper portion of the base 10 to measure a force applied from the upper side by the load support 30.

The load support 30 is connected to the upper portion of the load cell 20 to press the load cell 20.

The load support pulley 40 is coupled to the upper portion of the load support 30 to be rotatable according to the movement of the belt 70.

The guide pulleys 50-1 and 50-2 are disposed beside the load support pulley 40 so that a rotational shaft thereof is parallel to the load support pulley 40.

For example, as illustrated in FIG. 1, a pair of guide pulleys 50-1 and 50-2 may be disposed on both sides of the load support pulley 40 so that the rotational shaft thereof is parallel to the load support pulley 40. However, the guide pulleys 50-1 and 50-2 are used for maintaining a state where the belt 70 is bent at a predetermined angle and only any one of the pair of guide pulleys 50-1 and 50-2 illustrated in FIG. 1 may also be applied.

Hereinafter, as illustrated in FIG. 1, it will be described by assuming that the pair of guide pulleys 50-1 and 50-2 is applied.

The rotation angle measuring sensor 60 measures a rotation angle according to the rotation of the load support pulley 40. To this end, the rotation angle measuring sensor 60 is coupled to the load support 30 so as to be disposed at any one of both ends of the rotational shaft of the load support pulley 40.

For example, referring to FIG. 2, the rotation angle measuring sensor 60 may include a hall sensor 61 and a magnet 62. Herein, a plurality of magnets 62 is disposed at one end of the rotational shaft of the load support pulley 40 to form a predetermined rotation angle in a rotational direction and may rotate together with the load support pulley 40. The hall sensor 61 may be disposed at a position of the load support pulley 40 corresponding to a position of the magnet 62 so as to detect the magnetic force of each magnet 62 rotating together with the load support pulley 40.

For example, as the rotation angle measuring sensor 60, a rotary encoder for measuring the rotation angle may also be applied. The rotary encoder is rotatable at 360 degrees and outputs rotational motion to an electrical signal to use a principle of a variable resistance in which a resistance value varies according to the rotation direction and the rotation degree.

The belt 70 crosses with the load support pulley 40 and the pair of guide pulleys 50-1 and 50-2.

For example, one side of the belt 70 is connected to the exercise machine and the other side of the belt 70 may be connected to a handle which may be held by a user for exercise. In this case, the other side of the belt 70 may be connected to the handle via the load support pulley 40 and the pair of guide pulleys 50-1 and 50-2.

Hereinafter, an operation of the apparatus for measuring the exercise quantity according to the exemplary embodiment of the present invention including the above components will be described.

Generally, in many muscle exercise machines, a method of connecting a weight object and a person through a cable or a belt is applied. The person pulls the cable or the belt which is connected with the weight object to generate a load in the muscle of the person. At this time, tension is generated on the cable or the belt. That is, the tension generated on the cable or the belt corresponds to the load of the muscle according to the motion of the person.

As illustrated in FIG. 1, when the belt 70 is disposed on the load support pulley 40 and the pair of guide pulleys 50-1 and 50-2, when the belt 70 is pulled by the user to generate the tension, the load is generated to apply the force to the lower side of the load support 40 to which the load support pulley 40 is coupled.

Accordingly, the load cell 20 connected to the lower portion of the load support 30 may measure compression force in proportional to the tension of the belt 70. The belt 70 always generates the tension regardless of the movement and the structure of FIG. 1 has an advantage of measuring the tension regardless of the movement of the belt 70.

In addition, the rotation angle measuring sensor 60 measures a rotation angle of load support pulley 40 according to the movement of the belt 70. As a result, a movement distance of the belt may be calculated.

A force of pulling the belt 70 (a force applied by the person) may calculated from the force applied to the load cell 20 and the movement speed of the belt 70 may be calculated from the movement distance of the belt 70. In addition, a power rate may be calculated by multiplying the force of pulling the belt 70 and the movement speed of the belt 70. Herein, the calculated power rate may mean an instantaneous exercise quantity of the person and may be used as exercise data of the user.

Referring to FIG. 3, a force F of pulling the belt 70 may be calculated from a force Fs applied to the load cell 20 using the following Equation.

$$Fs = 2 F \cdot cos \frac{θ}{2} \qquad [ Equation 1 ]$$

Herein, θ represents an angle formed between the belt 70 between the load support pulley 40 and the pair of guide pulleys 50-1 and 50-2 and a horizontal line.

Meanwhile, the movement distance of the belt 70 may be calculated by multiplying a rotation angle change amount measured by the rotation angle measuring sensor 60 and a radius of the load support pulley 40.

FIG. 4 illustrates an electric generator mounted on the apparatus for measuring the exercise quantity according to the exemplary embodiment of the present invention.

The electric generator may be coupled to the load support pulley 40 so that the rotational shaft of the load support pulley 40 coincides with the rotational shaft of the electric generator. As a result, the electric generator may generate electric power by the rotation of the load support pulley 40 and the generated electric power may be supplied to the rotation angle measuring sensor 60. That is, when the electric generator is mounted on the apparatus for measuring the exercise quantity according to the exemplary embodiment of the present invention, the rotation angle measuring sensor 60 does not require separate electric power for driving and may be semipermanently used by receiving the electric power from the electric generator.

The exemplary embodiment of the present invention has been described for illustrative purposes, and those skilled in the art will appreciate that various changes, modifications, and additions are possible within the scope and spirit of the present invention, and it shall be considered that the changes, modifications, and additions are included in the appending claims of the present invention.

What is claimed is:

1. An apparatus for measuring an exercise quantity which is attached to an exercise machine using a belt, a cable, a rope, or a chain, the apparatus comprising:
a base fixed to the exercise machine;
a load cell mounted on the upper portion of the base to measure a force applied from the upper side;
a load support connected to the upper portion of the load cell to press the load cell;
a load support pulley coupled to the upper portion of the load support;
a guide pulley disposed beside the load support pulley so that a rotational shaft is parallel to the load support pulley; and
a rotation angle measuring sensor measuring a rotation angle according to the rotation of the load support pulley,
wherein the belt, the cable, the rope, or the chain crosses with the load support pulley and the guide pulley.

2. The apparatus of claim 1, wherein the rotation angle measuring sensor is coupled to the load support so as to be disposed at any one of both ends of the rotational shaft of the load support pulley.

3. The apparatus of claim 1, wherein the rotation angle measuring sensor includes
a plurality of magnets disposed at one end of the rotational shaft of the load support pulley at predetermined rotation angles in a rotation direction to rotate together with the load support pulley; and
a hall sensor disposed at a position of the load support corresponding to the position when the magnet is disposed so as to detect a magnetic force of the magnet.

4. The apparatus of claim 1, wherein the rotation angle measuring sensor is a rotary encoder measuring the rotation angle.

5. The apparatus of claim 1, wherein one side of the belt is connected to the exercise machine and the other side is connected to a handle which is held by a user for exercise, and the other side of the belt is connected to the handle via the load support pulley and the guide pulley.

6. The apparatus of claim 1, wherein when the belt is pulled by the user to generate tension, a load is generate to apply a force to the lower side of the load support to which the load support pulley is coupled.

7. The apparatus of claim 1, wherein a force of pulling the belt is calculated from the force applied to the load cell, a movement distance and a movement speed of the belt are calculated from the rotation angle, and a power rate is calculated by multiplying the force of pulling the belt and the movement speed of the belt.

8. The apparatus of claim 7, wherein the movement distance of the belt is calculated by a change amount of the rotation angle and a radius of the load support pulley.

9. The apparatus of claim 1, further comprising:
an electric generator that generates electric power by the rotation of the load support pulley and supplies the generated electric power to the rotation angle measuring sensor.

10. The apparatus of claim 9, wherein the electric generator is coupled to the load support so that the rotational shaft of the load support pulley coincides with the rotational shaft of the electric generator.
